(19) United States
(12) Patent Application Publication
(10) Pub. No.: US 2023/0036322 A1
(43) Pub. Date: Feb. 2, 2023

(54) FOLDABLE PROPELLER ASSEMBLY

(71) Applicant: Griff Aviation AS, SYKKYLVEN (NO)

(72) Inventor: Svein Even BLAKSTAD, SYKKYLVEN (NO)

(21) Appl. No.: 17/791,517

(22) PCT Filed: Jan. 8, 2021
(86) PCT No.: PCT/NO2021/050004

§ 371 Date: Jul. 7, 2022

(30) Foreign Application Priority Data
Jan. 10, 2020 (NO) 20200031

(51) Int. Cl. B64C 11/28; B64C 11/04

(52) U.S. Cl. CPC B64C 11/28; B64C 11/04

(57) ABSTRACT

A foldable propeller assembly for an aerial vehicle is disclosed herein. The foldable propeller assembly comprises a propeller blade arranged pivotably about a pivot axis and a first hub element arranged stationary relative to the pivot axis. The propeller blade or the first hub element comprises at least two openings provided about the pivot axis, each opening is configured for interlocking with a raised portion provided on the other one of the propeller blade and the first hub element. The at least two openings extend further about the pivot axis than the raised portion such that the propeller blade has limited play about the pivot axis when an opening is interlocking with the raised portion. A biasing element is arranged about the pivot axis and configured for biasing the propeller blade and the first hub element towards each other in an axial direction along the pivot axis.

The present invention relates to a foldable propeller assembly, and more specifically to a foldable propeller assembly for an aerial vehicle such as a drone.

### BACKGROUND

A key aspect of aerial vehicles, and in particular drones, is weight. The lighter the aerial vehicle is, the more lifting capacity it may have, and a longer flight-time may be achieved. As such, design of aerial vehicles today are on a large part based on weight-effective designs.

Also, an aerial vehicle such as a drone should be practical and easy to both store and transport, this is especially true for larger drones having large propeller blades.

As the propeller blades of an aerial vehicle may increase the overall width and length of the vehicle, a foldable propeller is a quick and effective way of reducing the overall size of an aerial vehicle.

There are many such foldable propeller assemblies, however, they all comprise several components to enable such a function, making it a complex mechanical assembly. Also, many known assemblies do not offer the required flexibility a foldable propeller should provide; the propeller blades should be foldable in both directions about a pivot axis, all the propeller blades of a propeller assembly should be foldable and the propeller blades should be foldable independent of each other.

Due to production tolerances, potential damages to the rotor blades, etc, the propeller blades should preferably have limited play, i.e. be allowed to pivot freely somewhat, even when the propeller blades are in the unfolded position. Such limited play may prevent imbalance in the rotor blades or the propeller assembly. This is important especially for large aerial vehicles with large and relatively heavy propeller blades, where imbalance in the propeller blades will affect the performance of the aerial vehicle more so than on smaller aerial vehicles. Further, there is a need in the art for a foldable propeller assembly that alleviates vibrations in the propeller blade.

It is therefore a need for an improved foldable propeller assembly that is lightweight, do not have any limitations in direction of folding and is allowed to pivot somewhat even in an unfolded position. It is a further advantage to devise a foldable propeller formed from simple and cost-effective components. It is an objective of the present invention to achieve this and to provide further advantages over the state of the art.

Documents useful for understanding the field of technology include WO18172754A1, US20170283050A1 and CN205661661U. The prior art also includes WO 2014141154A1 and CN 209833980 U, both describing systems of foldable propellers.

### SUMMARY

It is an object of the present invention to mitigate, alleviate or eliminate one or more of the above-identified deficiencies and disadvantages in the prior art and solve at least the above mentioned problem.

According to a first aspect, there is provided a foldable propeller assembly for an aerial vehicle, comprising a propeller blade arranged pivotably about a pivot axis; a first hub element arranged stationary relative to the pivot axis; the propeller blade or the first hub element comprises at least two openings provided about the pivot axis, each opening is configured for interlocking with a raised portion provided on the other one of the propeller blade and the first hub element; where the at least two openings extend further about the pivot axis than the raised portion such that the propeller blade has limited play about the pivot axis when an opening is interlocking with the raised portion; a biasing element arranged about the pivot axis and configured for biasing the propeller blade and the first hub element towards each other in an axial direction along the pivot axis.

According to an embodiment of the invention, the propeller blade comprises a bushing element, and the at least two openings or the raised portion are arranged on the bushing element.

According to an embodiment of the invention, the bushing element comprises a non-circular portion configured for mating with a corresponding non-circular propeller opening on the propeller blade.

According to an embodiment of the invention, the raised portion is a fixed element on the propeller blade or the first hub element.

According to an embodiment of the invention, a plurality of openings and a plurality of raised portions are provided in pairs about the pivot axis.

According to an embodiment of the invention, the foldable propeller assembly further comprises a second hub element arranged stationary relative to the pivot axis.

According to an embodiment of the invention, the propeller blade and the biasing element are positioned axially between the first hub element and the second hub element.

According to an embodiment of the invention, the biasing element is positioned below the propeller blade and the propeller blade is positioned below the first hub element.

According to an embodiment of the invention, the biasing element is a spring washer.

According to an embodiment of the invention, the foldable propeller assembly comprises three propeller blades each arranged pivotably about a respective pivot axis.

The present invention will become apparent from the detailed description given below. The detailed description and specific examples disclose preferred embodiments of the invention by way of illustration only. Those skilled in the art understand from guidance in the detailed description that changes and modifications may be made within the scope of the invention.

Hence, it is to be understood that the herein disclosed invention is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an” and “the” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTION OF THE DRAWINGS

The above objects, as well as additional objects, features and advantages of the present invention, will be more fully appreciated by reference to the following illustrative and non-limiting detailed description of example embodiments of the present invention, when taken in conjunction with the accompanying figures.

FIG. 1 shows a top view of an embodiment of a foldable propeller assembly in an unfolded state.

FIG. 2 shows a top view of a foldable propeller assembly in a folded state.

FIG. 3 shows an exploded view of an embodiment of a foldable propeller assembly.

FIG. 4 shows a side view of a detail of the foldable propeller assembly.

FIG. 5 shows an embodiment of an underside of a first hub element.

FIG. 6 shows a side view of an embodiment of a bushing element.

FIG. 7 shows a view from below of the bushing element.

### DETAILED DESCRIPTION

The present invention will now be described with reference to the accompanying figures, in which preferred example embodiments of the invention are shown. The invention may, however, be embodied in other forms and should not be construed as limited to the herein disclosed embodiments. The disclosed embodiments are provided to fully convey the scope of the invention to the skilled person.

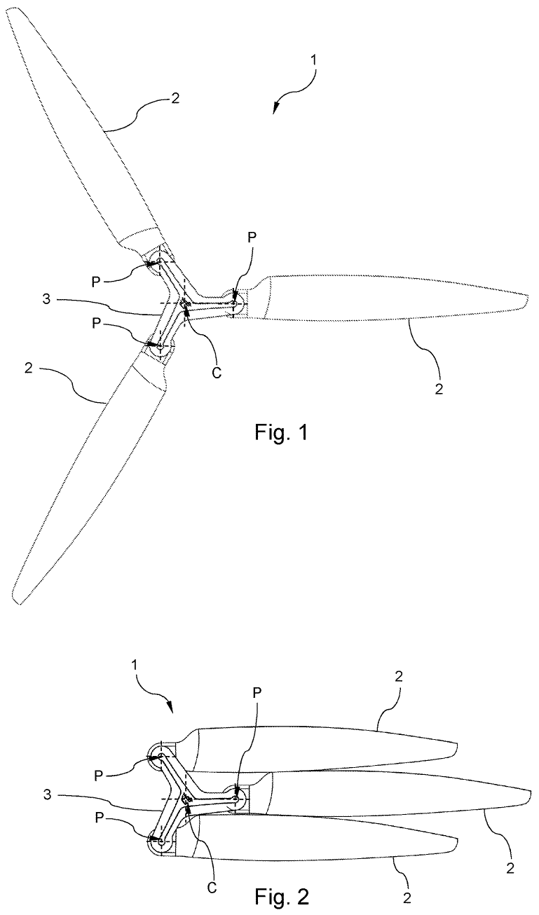

Referring initially to FIGS. 1 and 2, an embodiment of a foldable propeller assembly 1 is shown. The foldable propeller assembly 1 may be mounted on e.g. an aerial vehicle such as a drone. The foldable propeller assembly 1 is shown in an unfolded state in FIG. 1, and in a folded state in FIG. 2. The illustrated embodiment of the foldable propeller assembly 1 comprises three propeller blades 2, and in the unfolded position of FIG. 1 the propeller blades 2 extend in a radial direction from a center axis C. The center axis C is the axis the propeller assembly 1 rotates about. The foldable propeller assembly 1 is commonly powered by a motor to rotate about the center axis 1. The propeller blades 2 are connected to a first hub element 3, and the first hub element 3 is configured to rotate about the center axis C and as such rotate the propeller blades 2.

To pivot the propeller blades 2 from the unfolded state to the folded state, an operator may simply pull or push the propeller blades 2 by hand from their interlocked position with the first hub element 3 in the unfolded state, and pivot the individual propeller blades 2 about each respective pivot axis P until the propeller blades 2 are interlocked with the first hub element 3 in a second position, such as the folded state in FIG. 2.

In the folded position of FIG. 2, two of the propeller blades 2 have been pivoted about their respective pivot axis P such that all three propeller blades 2 extend in parallel in the same direction. The first hub element 3 may not have been rotated. In the illustrated embodiment, the direction of the folded propeller blades 2 corresponds to the unfolded direction of one of the propeller blades 2. In the folded position of the illustrated embodiment, the upper propeller blade 2 has been pivoted with the clock, while the lower propeller blade 2 has been pivoted against the clock. As the propeller blades 2 are in a folded state, the propeller assembly is more compact and the propeller assembly 1 itself, and the aerial vehicle it is mounted to, is thus easier to store and transport.

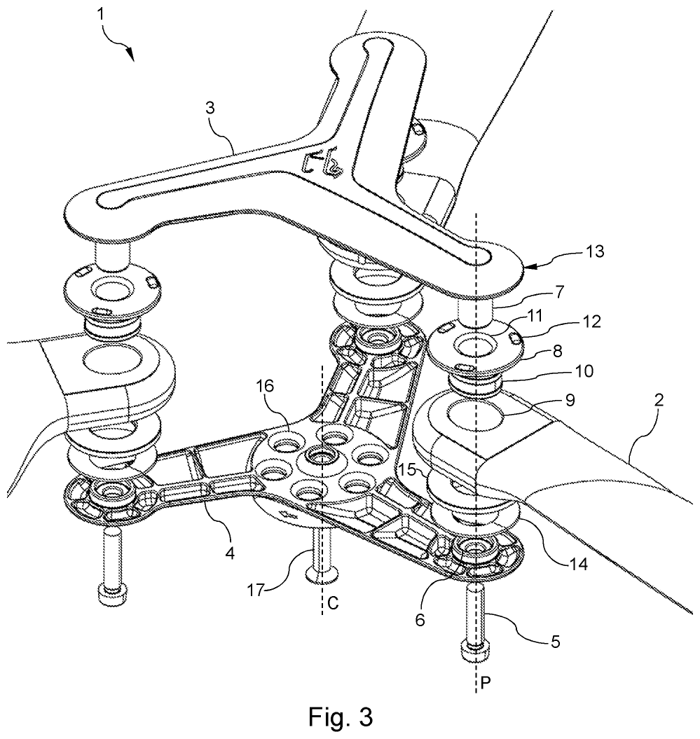

Referring now to FIG. 3, an exploded view of the foldable propeller assembly 1 is shown. The propeller blade 2 is arranged pivotably about the pivot axis P. The first hub element 3 is arranged stationary relative to the pivot axis P, and in the illustrated embodiment the first hub element 3 is positioned on top of the propeller blade 2. The hub element 3 may connect any number of propeller blades 2 and pivot axes P, but a foldable propeller assembly 1 comprising three propeller blades 2 may be preferred for allowing all three propeller blades 2 to be arranged in parallel, in the same direction, as illustrated in FIG. 2. The hub element 3 may as such be formed as a star comprising three arms extending from the center axis C.

The first hub element 3 may be connected to a second hub element 4 by a connecting member 5. The connecting member 5 may be a bolt or other fastening member, and may be configured to connect the first hub element 3 to the second hub element 4, while also providing support for the propeller blade 2 to pivot about.

The second hub element 4 may be arranged stationary relative to the pivot axis P, and the second hub element 4 may be shaped correspondingly to the first hub element 3, i.e. with portions supporting the pivot axes P, and the second hub element 4 also being configured to rotate about the center axis C. A center connecting member 17 may additionally fix the first hub element 3 to the second hub element 4 along the center axis C.

The propeller blade 2 is in the illustrated embodiment positioned along the pivot axis P between the first and second hub elements 3, 4. The connecting member 5 may be a bolt that extends through a hub opening 6 in the second hub element 4 and is fastened to a connection portion 7 of the first hub element 3. The connection portion 7 may extend into the propeller blade 2, for ensuring sufficient fixing with the connection member 5 and providing support for the propeller blade 2. In the illustrated embodiment, the pivot axis P coincides with a longitudinal axis of the connecting member 5.

The propeller blade 2 may comprise a bushing element 8. The bushing element 8 may be an insert in the propeller blade 2, and may be made in a different, preferably harder, material than the propeller blade 2. The propeller blade 2 may be made from e.g. a composite plastic material and the bushing element 8 may be made from e.g. a metal. The first hub element 3 may also be made of metal, such that the contact between the first hub element 3 and the bushing element 8 is metal to metal. The bushing element 8 may be inserted into a propeller opening 9 that may be non-cylindrical. The bushing element 8 may have a corresponding non-cylindrical portion 10 configured for insertion into the propeller opening 9. The non-cylindrical portion 10 is shown and described further with reference to FIG. 7. When the non-cylindrical portion 10 of the bushing element 8 is inserted into the propeller opening 9, the bushing element 8 is prevented from rotation relative to the propeller blade 2, and the bushing element 8 thus acts as a reinforcement of the propeller blade 2. Additionally, the bushing element 8 may be glued or otherwise fixed to the propeller blade opening 9. The bushing element 8 comprises a bore 11 through the center. The bore 11 may be cylindrical, extending thorough the non-cylindrical portion 10. The connection portion 7 and connecting member 5 may partly or fully extend through the bore 11.

The bushing element 8 may comprise one or more raised portions 12. Alternatively, if the propeller blade 2 does not comprise a bushing element 8, the one or more raised portions 12 may be provided directly on the propeller blade 2. In the illustrated embodiment, the bushing element 8 comprises three raised portions 12 provided evenly distributed around the pivot axis P, i.e. the raised portions are arranged at intervals of 120° about the pivot axis P. The raised portions 12 may be humps, protrusions or similar, configured for interlocking with corresponding openings 13 on the first hub element 3. The openings 13 are not visible in FIG. 3, but the position of the openings 13 are indicated with an arrow. The openings 13 are illustrated more in detail with reference to FIG. 5. The raised portions 12 are preferably fixed to the bushing element 8 (or the propeller 2 if there is no bushing element 8), such that the raised portions 12 provide a secure interlocking with the openings 13.

The openings 13 could be through-holes, recesses, grooves or similar absence of material, and the openings 13 are thus configured for receiving the raised portions 12. The openings 13 are provided about the pivot axis P.

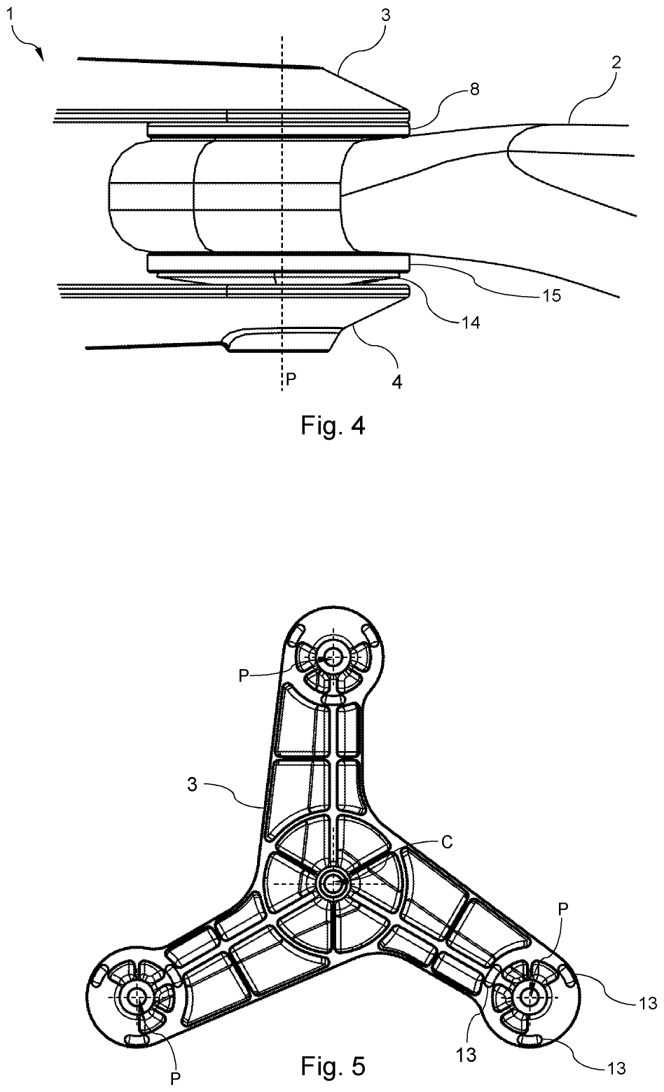

In order to accommodate the raised portions 12 in the openings 13, the openings 13 may preferably be dimensioned such that the depth of the openings 13 is greater than the height of the raised portions 12. When in an interlocking position, where a raised portion 12 is pivoted to interlocking with an opening 13, an upper portion of the propeller blade 2 will thus be parallel and in contact with the underside of the first hub element 3, as illustrated in FIG. 4.

The openings 13 extend further about the pivot axis P than the raised portions 12 do, such that when the raised portions 12 are accommodated inside the openings 13, the propeller blade 2 is allowed to freely pivot somewhat about the pivot axis P, i.e. the propeller blade 2 has limited play. The openings 13 may extend about the pivot axis P e.g. a few millimeters more than the raised portions 12 do. The openings 13 may e.g. extend 1-5 millimeters more about the pivot axis P than the raised portions 12 do. As such, the propeller blade 2 may be allowed to pivot e.g. between 1-10° when the raised portions 12 are accommodated inside the openings 13. This allowed tolerance of movement provides the propeller assembly 1 with an ability to self-balance the propeller blades 2 as the propeller assembly 1 rotates about the center axis C.

When a propeller blade 2 is in an interlocked position with the first hub element 3, the one or more raised portions 12 are accommodated inside corresponding openings 13. As a user forces a propeller blade 2 to pivot about a respective pivot axis P, the raised portions 12 are forced out of their corresponding opening 13. The propeller blade 2 may be pivoted until the one or more raised portions 12 are accommodated into a next opening 13.

The more openings 13 are provided in the first hub element 3 about the pivot axis P, the more such interlocking positions a foldable propeller assembly 1 may be provided with. Raised portions 12 and openings 13 may be provided in pairs, in order to maximize interlocking between the propeller blade 2 and the first hub element 3. The illustrated embodiment comprises three raised portions 12 and three corresponding openings 13, such that each propeller blade 2 may be pivoted from an unfolded position as shown in FIG. 1, to a folded position either left or right about the pivot axis P, to the folded position as shown in FIG. 2.

As the skilled reader will appreciate, the arrangement of the raised portions 12 and openings 13 could be reversed, such that the raised portions 12 could be provided on the first hub element 3, and the openings 13 could be provided on the propeller blade 2 or the hub element 8.

The foldable propeller assembly 1 further comprises a biasing element 14. The biasing element 14 is configured for biasing the propeller blade 2 and the first hub element 3 towards each other in an axial direction along the pivot axis P. In the illustrated embodiment, the biasing member 14 is positioned below the propeller blade 2. The biasing element 14 forces the propeller blade 2 and the first hub element 3 against each other, and the raised portions 12 and openings 13 mate if they are positioned facing each other. If the raised portions 12 are not accommodated in the openings 13, the compressible nature of the biasing element 14 allows the propeller blade 2 to separate somewhat from the first hub element 3, thereby allowing the raised portions 12 to pivot out of one opening 13 into accommodation with the next opening 13.

The biasing element 14 is in the illustrated embodiment a spring washer, but may as such be any element configured to exert a biasing force. A spring washer is a disc cone shaped element, usually made of steel, that may be positioned around an axis and that may exert a force in an axial direction upon compression, due to the shape of the element. The biasing element 14 may alternatively be a helical spring or other compressible element. However, a spring washer is compact and may distribute a biasing force evenly about the pivot axis P to the propeller blade 2. The biasing element 14 is arranged around the pivot axis P, and in the illustrated embodiment, the biasing element 14 is positioned between the propeller blade 2 and the second hub element 4. As the biasing element 14 is compressible and positioned around the pivot axis P, it's biasing force is evenly distributed, and it also stabilizes and reduces vibrations in the propeller blade 2.

In the illustrated embodiment, the biasing element 14 is positioned below the propeller blade 2, and the first hub element 3 is positioned above the propeller blade 2. Such an arrangement may be preferred, because upon rotation of the foldable propeller assembly 1, the propeller blade 2 is forced upwards due to the lift that is created. It is this lifting force that may provide the aerial vehicle with an upwards movement. This lifting force is added to the force the biasing element 14 exerts on the propeller blade 2. During the upwards biasing force from the propeller blade 2 to the hub element 3, the openings 13 and raised portions 12 are further pressed together, increasing the effect of the interlocking as the propeller blade 2 and hub element 3 are forced together.

A washer 15 may be provided between the biasing element 14 and the propeller 2, for reducing friction as the propeller blade 2 is pivoted around the pivot axis P.

The second hub element 4 may be connected to a rotating means at the center. The rotating means is not shown, but may be e.g. a gear, a shaft or a motor, configured to rotate the foldable propeller assembly 1 about the center axis C. The illustrated embodiment comprises six connection means 16 spaced around the center axis C, for connecting the foldable propeller assembly 1 to such a rotating means. The connection means 16 may simply be holes, through which fastening means such as bolts may fix the foldable propeller assembly 1 to the rotating means. The first hub element 3 may also be connected to the second hub element 4 at the center, and, alternatively, the first hub element 3 may be directly connected to the rotating means, without a second hub element 4.

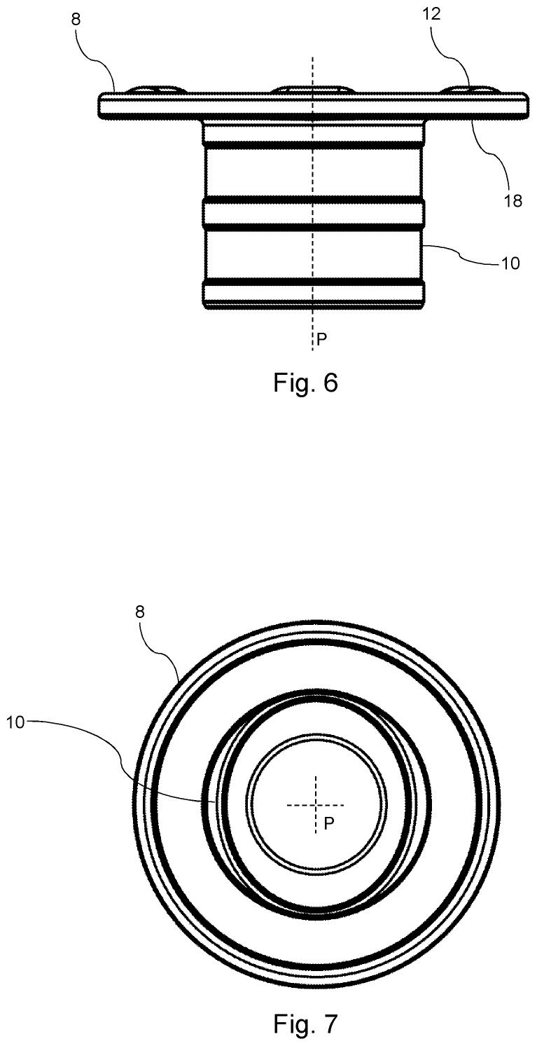

Referring now to FIG. 4, a portion of the foldable propeller assembly 1 is seen from the side. FIG. 4 illustrates how the different parts of the foldable propeller assembly 1 are sandwiched together about one pivot axis P when the one or more raised portions are accommodated in corresponding openings. The first hub member 3 is positioned on top. The first hub member 3 comprises openings (not shown in FIG. 4, see FIG. 5) provided on the underside. The propeller blade 2 comprises the bushing element 8, and raised portions (not shown in FIG. 4, see FIGS. 3 and 6) on the bushing element 8 extend upwards, generally in an axial direction, towards the first hub member 3. When the raised portions are interlocking with the openings, the first hub member 3 and the bushing element 8 are in close contact.

Upon pivoting the propeller blade 2, and consequently the bushing element 8, about the pivot axis P, the raised portions are forced out of their respective openings, and the first hub member 3 and the bushing element 8 are thus separated a distance corresponding to the height of the raised portions. The flexible nature of the biasing element 14 allows this separation. The biasing element 14 is provided below the propeller blade 2, between the propeller blade 2 and the second hub element 4. As previously mentioned, a washer 15 may be provided between the biasing element 14 and the underside of the propeller blade 2 for reducing friction between the biasing element 14 and the propeller blade 2.

FIG. 5 shows an embodiment of an underside of the first hub element 3. The first hub element 3 of the illustrated embodiment comprises three pivot axes P, and three propeller blades are configured to be pivotably connected to the first hub element 3, each pivotable about a respective pivot axis P. In the illustrated embodiment, three openings 13 are provided around each pivot axis P on the first hub element 3. The openings 13 are in the illustrated embodiment elongate, and extend about the pivot axis P in a circumferential direction about the axis P. The three openings 13 are equally spaced apart about the pivot axis P, and the openings are thus arranged spaced apart 120° about the pivot axis.

Referring now to FIGS. 6 and 7, the bushing element 8 is shown in greater detail. The raised portions 12 are provided on a flange portion 18 of the bushing element 8, and are provided as smooth humps that may be pivoted in and out of the openings as the propeller blade and bushing element 8 are pivoted about the pivot axis P. The non-circular portion 10 is in the illustrated embodiment shaped elliptical, but may as such be any shape that prevents rotation when inserted into an accommodating opening. The propeller opening may as such not correspond exactly to the non-circular portion 10, but must prevent the bushing element 8 from rotation when it is inserted in the propeller opening.

The person skilled in the art realizes that the present invention is not limited to the preferred embodiments described above. The person skilled in the art further realizes that modifications and variations are possible within the scope of the appended claims. Additionally, variations to the disclosed embodiments can be understood and effected by the skilled person in practicing the claimed invention, from a study of the drawings, the disclosure, and the appended claims.

1. A foldable propeller assembly for an aerial vehicle, comprising:
a propeller blade arranged pivotably about a pivot axis; and
a first hub element arranged stationary relative to the pivot axis;
wherein the propeller blade or the first hub element comprises at least two openings provided about the pivot axis, and each opening is configured for interlocking with a raised portion provided on the other one of the propeller blade and the first hub element;
wherein the at least two openings extend further about the pivot axis than the raised portion such that the propeller blade has limited play about the pivot axis when an opening is interlocking with the raised portion; and
a biasing element arranged around the pivot axis and configured for biasing the propeller blade and the first hub element towards each other in an axial direction along the pivot axis.

2. The foldable propeller assembly of claim 1, wherein the propeller blade comprises a bushing element, and the at least two openings or the raised portion are fixedly arranged on the bushing element.

3. The foldable propeller assembly of claim 2, wherein the bushing element comprises a non-circular portion configured for mating with a corresponding non-circular propeller opening on the propeller blade.

4. The foldable propeller assembly of claim 1, wherein the raised portion is a fixed element on the propeller blade or the first hub element.

5. The foldable propeller assembly of claim 1, wherein a plurality of openings and a plurality of raised portions are provided in pairs about the pivot axis.

6. The foldable propeller assembly of claim 1, wherein the foldable propeller assembly further comprises a second hub element arranged stationary relative to the pivot axis.

7. The foldable propeller assembly of claim 6, wherein the propeller blade and the biasing element are positioned axially between the first hub element and the second hub element.

8. The foldable propeller assembly of claim 1, wherein the biasing element is positioned below the propeller blade and the propeller blade is positioned below the first hub element.

9. The foldable propeller assembly claim 1, wherein the biasing element is a spring washer.

10. The foldable propeller assembly of claim 1, wherein the foldable propeller assembly comprises three propeller blades each arranged pivotably about a respective pivot axis.

11. A foldable propeller assembly for an aerial vehicle, comprising:
a propeller blade arranged pivotably about a pivot axis; and
a first hub element arranged stationary relative to the pivot axis, wherein:
each opening of at least two openings, which are provided about the pivot axis, of the propeller blade or of the first hub element is configured for interlocking with a raised portion provided on the other one of the propeller blade and the first hub element;
the at least two openings extend further about the pivot axis than the raised portion such that the propeller blade has limited play about the pivot axis when a particular opening of the at least two openings is interlocking with the raised portion; and
a biasing element is arranged around the pivot axis and configured for biasing the propeller blade and the first hub element towards each other in an axial direction along the pivot axis.

12. The foldable propeller assembly of claim 11, wherein the propeller blade comprises a bushing element, and the at least two openings or the raised portion are fixedly arranged on the bushing element.

13. The foldable propeller assembly of claim 12, wherein the bushing element comprises a non-circular portion configured for mating with a corresponding non-circular propeller opening on the propeller blade.

14. The foldable propeller assembly of claim 11, wherein the raised portion is a fixed element on the propeller blade or the first hub element.

15. The foldable propeller assembly of claim 11, wherein a plurality of openings and a plurality of raised portions are provided in pairs about the pivot axis.

16. The foldable propeller assembly of claim 11, wherein the foldable propeller assembly further comprises a second hub element arranged stationary relative to the pivot axis.

17. The foldable propeller assembly of claim 16, wherein the propeller blade and the biasing element are positioned axially between the first hub element and the second hub element.

18. The foldable propeller assembly of claim 11, wherein the biasing element is positioned below the propeller blade and the propeller blade is positioned below the first hub element.

19. The foldable propeller assembly of claim 11, wherein the biasing element is a spring washer.

20. The foldable propeller assembly of claim 11, wherein the foldable propeller assembly comprises three propeller blades each arranged pivotably about a respective pivot axis.
